(19) United States
(12) Patent Application Publication
(10) Pub. No.: US 2009/0083124 A1
(43) Pub. Date: Mar. 26, 2009

(54) Message transmission

(76) Inventor: Roger Murphy, Erdington (GB)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 11/903,119

(22) Filed: Sep. 20, 2007

(51) Int. Cl. G06Q 30/00; G06F 17/30; G06F 17/40

(52) U.S. Cl. 705/10

(57) ABSTRACT

A method is disclosed of permitting a supplier to transmit a message through an agent, to potential customers including the steps of creating a plurality of personal customer records which each includes customer identification information and customer preference information, storing the personal customer records in a database of personal customer records, and in response to an enquiry to the agent from a supplier relating to the customer preference information, the agent providing a message from the supplier to customers selected by the agent on the basis of the customer preference information.

### DESCRIPTION OF INVENTION

This invention relates to a method of message transmission, and more particularly to a method which permits a supplier to transmit a message, such as an advertising message, through an agent, to customers.

Consumers today are subject to many and varied forms of advertising which in the main is undirected. Supermarkets and the like collect customer data by matching purchase history with customer identification, such as for example through credit card transactions, in an effort to make promotion of its products more pertinent to its customers; and even to direct specific advertising to specific customers where a customer address/email etc can be ascertained, for example from loyalty schemes to which customers have to register.

However in each case, the advertising a customer receives is entirely beyond its control, and much of the advertising the customer will receive will be unwanted spam.

According to a first aspect of the invention I provide a method of permitting a supplier to transmit a message through an agent, to potential customers. The method may include the steps of creating a plurality of personal customer records which each includes customer identification information and customer preference information, storing the personal customer records in a database of personal customer records, and in response to an enquiry to the agent from a supplier relating to the customer preference information, the agent providing a message from the supplier to customers selected by the agent on the basis of the customer preference information.

The present invention thus enables suppliers to direct their messages e.g. advertising, via the agent, specifically to customers who have indicated a preference for receiving such specific advertising. The invention may thus bring benefits both for suppliers and customers as suppliers can direct their advertising only to potentially interested customers, and customers will only receive advertising of interest to them.

A customer selected by the agent may decide not respond to the supplier's message. However the method may include permitting a customer in receipt of a message from a supplier, to respond to the supplier's message through the agent, or to contact the supplier directly. For example a customer may request more information from the supplier. In each case, desirably, the customer's customer identification information is not disclosed to the supplier by the agent unless the customer initiates the supply of such identification information. Preferably though a message transmitted to a customer by the agent will include the supplier's contact information so that the customer may choose to contact the supplier directly.

The method may include the agent rendering a charge to the supplier for providing the message to selected customers when the customer responds to the message.

Thus a supplier only pays for e.g. an advertising message which attracts the interest of a customer selected by the agent.

The method may include, in the event that a customer responds to a supplier's message, the agent awarding the customer a reward. Most conveniently the reward will be consumer points, details of which may be stored in the customer's personal customer record, the consumer points being redeemable against a subsequent purchase of a product made from the or another supplier.

The method may include creating a personal supplier record including supplier contact information, and supplier product information, and storing the personal supplier record on a database of personal supplier records. The method of the invention may include in response to an enquiry from a customer relating to the supplier product information, the agent providing a message from the customer to suppliers selected on the basis of the stored supplier product information.

The product may be in the nature of goods and/or services.

According to a second aspect of the invention I provide a system for performing the method of the first aspect of the invention including a database of personal customer records including customer identification information and customer preference information for each customer, a database of personal supplier information including supplier contact information and supplier product information, an agent which includes information processing means, which is responsive to an enquiry from a supplier relating to the supply of a particular product or products, to provide a message from the supplier to customers selected on the basis of the customer preference information.

### BRIEF DESCRIPTION OF THE DRAWINGS

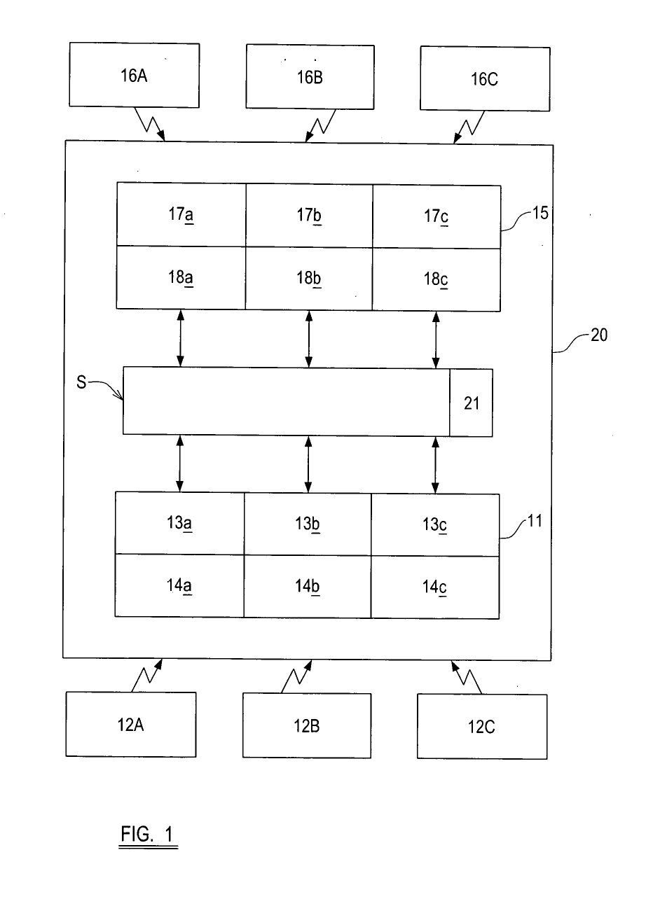

Implementations of the invention will now be described with reference to the accompanying illustrative FIG. 1 which is a block diagram of the system.

### DETAILED DESCRIPTION OF THE PREFERRED EMBODIMENTS

Referring to the drawing there is shown a system 10 for enabling each of a plurality of suppliers 16A, 16B, 16C etc. to send messages, particularly advertising messages, via an agent 20, to selected customers 12A, 12B, 12C etc. In the example, the agent 20 is a server S and processing device 21 which is accessible to receive and transmit from and to the internet.

Whereas in general, advertising is undirected leading to consumer dissatisfaction with the onslaught of unwanted spam, the system 10 permits each individual customer 12A, 12B, 12C etc. to upload to an agent 20, its preferences so that suppliers may be more directed with their advertising i.e. advertising to customers who may potentially be interested in the supplier's products, and customers may only receive advertising of interest.

The system 10 enables a personal customer record 13a, 14a; 13b, 14b; 14a, 14b to be created for each customer 12A, 12B, 12C etc. This may be achieved in many different ways, but in the example illustrated, each customer 12A, 12B, 12C etc. may fill in online, an electronic form, in order to provide both customer identification information 13a, 13b, 13c etc., and customer preference information 14a, 14b, 14c etc.

The customer identification information 13a, 13b, 13c etc. may include the customer's name, physical address, email address, and telephonic communication numbers etc.

The customer preference information 14a, 14b, 14c etc. may include information about a wide range of possible interests to the customer, including but not limited to each customer's culinary and gastronomic preferences, activity (sports, hobby and recreational) preferences, holiday preferences, motoring preferences, personal information such as whether the customer might have any interest in products relating to childcare, medical care and so on.

The customer preference information 14a, 14b, 14c, etc. may include information relating to some immediate requirement. For example only, the customer preference information may indicate that the customer is looking to buy a new product such as a TV.

The customer preference information 14a, 14b, 14c may thus include in a common format for all customers, detailed information relating to products for which the customers may individually be interested in receiving advertising. Each customer's customer preference information 14a, 14b, 14c etc. and associated customer identification information 13a, 13b, 13c etc. is uploaded to the agent 20, e.g. via a respective internet connection, where it is stored in a database 11 of personal customer information.

The system 10 similarly permits a personal supplier record 17a, 18a; 17b, 18b; 17c, 18c etc. to be created for each of a plurality of suppliers 16A, 16B, 16C etc.

Each personal supplier record 17a, 18a; 17b, 18b; 17c, 18c etc. includes supplier contact information 17a, 17b, 17c etc., and supplier product information 18a, 18b, 18c.

The supplier contact information 17a, 17b, 17c etc. may include the supplier's name, physical address, email address, and telephonic communication numbers etc.

The supplier product information 18a, 18b, 18c may include information, such as but not limited to advertising, relating to products which the suppliers 16A, 16B, 16C etc. wish to offer for sale to customers.

The personal supplier records 17a 18a; 17b, 18b; 17c, 18c may be uploaded to the agent 20, e.g. via a respective internet connection, where it is stored in a database 15 of personal supplier information.

The system 10 may be operated as follows.

With personal customer records 13a, 14a; 13b, 14b; 13c, 14c stored by the agent 20 for a plurality of customers 12A, 12B, 12C etc., in the event that a supplier 16A, 16B, 16C etc. wishes to advertise a particular product or more generally to place an advertising message, the supplier 16A, 16B, 16C etc. sends an enquiry to the agent 20 of the system 10, again over the internet connection for example. The enquiry may relate to supplier product information 18a, 18b, 18c etc. which may already be stored in the database 15, of personal supplier records, or the enquiry may include supplier product information 18a, 18b, 18c etc. to be then stored in the database 15 of personal supplier records.

The enquiry may include a message such as an advertising message relating to the particular product which the supplier 16A, 16B, 16C etc. wishes to send to potential customers. The enquiry may identify the supplier e.g. may include the supplier's supplier contact information 17a, 17b, 17c etc., such as for example a link to the supplier's website.

Depending on the nature of the enquiry, the agent 20 will select customers 12A, 12B, 12C etc. based on the customer preference information 14a, 14b, 14c etc. stored in the database 11 of personal customer records the selected customers 12A, 12B, 12C etc. being those who have indicated a preference to receive advertising messages relating to the particular product.

The agent 20 will then direct the message from the supplier 16A, 16B, 16C etc. to the selected customers 12A, 12B, 12C e.g. by emailing the customers, or more preferably by posting messages to the selected customers' personal web pages which may be stored on the server S and which are accessible over the internet, by the respective customers 12A, 12B, 12C. However, the customers' identification information 13a, 13b, 13c will not be revealed to the supplier 16A or 16B or 16C and thus the potentially interested customers will remain anonymous.

By way of a specific example, a supplier 16A, 16B, 16C etc. wishing to sell particular wine, for example French wine, may send an enquiry with a suitable advertising message relating to the wine being offered, which information will be stored in the database 15 of personal supplier records.

The agent 20 will identify any customer for which customer preference information is stored in the database of personal customer records 11 which indicates that the customer 12A and/or 12B and/or 12C may have an interest in French wine, and transmit the supplier's message to be posted on the personal web pages of the selected customers 12A, 12B, 12C etc. for viewing the next time the customer logs into the agent's server S over the internet.

With the supplier's advertising message displayed, each selected customer 12A, 12B 12C etc. may opt to delete the message, store the message for future reference, or to respond to the message e.g. by selecting (i.e. “clicking” on) the message where the message includes a suitable link. The message may also include additional information about the product offered by the supplier which may be viewed by accessing a further page or pages of the message, again for example by selecting (i.e. “clicking” on) a part of the displayed message.

Where a customer decides to respond to the message, the agent 20 may provide a response message to the supplier. For example, the advertising message may offer more information about a product. The agent 20 may act as an intermediary so that a response may be sent to the supplier without disclosing the identity of the customer. Alternatively, the advertising message may include a link direct to the supplier's website in which case there may be interactive communication between the customer and the supplier e.g. by linking the customer with the supplier's website, so that if desired, the customer 12A, 12B, 12C etc. may enter into a transaction with the supplier e.g. for the purchase of the French wine or other product offered.

Only if a customer decides to disclose its identity in response to a supplier's advertising message may the identity of the customer become known to the supplier and only if the customer discloses this to the supplier i.e. there is no need for the system 10 to provide any supplier 16A, 16B, 16C etc. with any customer identity information, as for example any purchase transaction will be between the customer and supplier direct over the internet.

However, if a customer 12A, 12B, 12C etc. indicates when providing its customer preference information 14a, 14b, 14c to the agent 20 that the customer is willing to receive messages direct from suppliers 16A, 16B, 16C etc. and possibly in paper/telephonic format, upon selecting customers in response to a supplier 16A, 16B, 16C etc. enquiry, the agent 20 may additionally to transmitting the message to the customers' web pages as described above, provide to the supplier the selected customer's customer identification information 13a, 13b, 13c, etc. so that the supplier may make direct contact with the customer.

In the event that a selected customer responds in any way to a supplier's message (and optionally also when merely accessing additional information of the message), the agent renders a charge to the supplier for providing the advertising or other message to the selected customer. Additionally the customer may be awarded a reward, such as for example the allocation of consumer points which the customer may subsequently redeem against purchases from the supplier who sent the advertising message, or another of the suppliers 16A, 16B, 16C etc. who may subscribe to the system 10 but more desirably, the agent may award consumer points for redemption e.g. in the form of vouchers to be spent on products in retail outlets which may or may not belong to the suppliers or the customer may redeem his points to a charity, through the agent 20 or by surrendering vouchers.

Yet another possibility is that a customer may request that accumulated points are provided to, for example, a utility to settle a utility bill, or more generally to any external body for which the agent has details in the customer database 11, which the customer nominates to receive the consumer points, or a monetary value for the consumer points accumulated.

Details of the customers' tallies of consumer points may be stored e.g. in the database of personal customer records 11. A customer may redeem any consumer points awarded for example only, by the agent 20 monitoring the accumulation of consumer points and automatically sending an electronic notification or paper points voucher to a customer either on the customer's e.g. email, request, or when the customer's points tally has reached a threshold. If desired, the supplier's 16A, 16B, 16C etc. may enable customers to redeem consumer points upon making on-line purchases e.g. by the customer entering a voucher code which may be verified by the supplier then seeking consumer points information from the database of personal customer records 11.

Various modifications are possible without departing from the scope of the present invention. However in each case, a supplier may transmit a message such as an advertisement to customers selected by the processing device 21 depending upon the customer preference information stored in the database of personal customer records

A customer in search of a particular product may use the system 10 to post an enquiry, with the system 10 sending a message to one or more selected suppliers 16A, 16B, 16C etc. who may be able to offer the product.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of permitting a supplier to transmit a message through an agent, to potential customers including the steps of creating a plurality of personal customer records which each includes customer identification information and customer preference information, storing the personal customer records in a database of personal customer records, and in response to an enquiry to the agent from a supplier relating to the customer preference information, the agent providing a message from the supplier to customers selected by the agent on the basis of the customer preference information.

2. A method according to claim 1 wherein the message from the supplier to the customer via the agent is an advertising message.

3. A method according to claim 1 wherein the method includes permitting a selected customer in receipt of a message via the agent from a supplier, to respond to the supplier's message.

4. A method according to claim 3 wherein the method includes permitting the customer in receipt of a message from a supplier to respond to the supplier's message by requesting more information from the supplier.

5. A method according to claim 3 wherein the supplier's message includes the supplier's contact information so that the customer may choose to contact the supplier directly.

6. A method according to claim 3 wherein the agent renders a charge to the supplier for providing the message to selected customers, when the customer responds to the message.

7. A method according to claim 3 wherein the method includes the agent awarding a responding customer a reward.

8. A method according to claim 7 wherein the reward is consumer points, which are redeemable against a subsequent purchase of a product made from one of the supplier, another supplier, and a retail outlet.

9. A method according to claim 8 wherein details of a customer's rewards are stored in the customer's personal customer record.

10. A method according to claim 1 including creating a personal supplier record including supplier contact information, and supplier product information, and storing the personal supplier record on a database of personal supplier records.

11. A method according to claim 10 wherein the method includes, in response to an enquiry from a customer relating to the supplier product information, the agent providing a message from the customer to suppliers selected on the basis of the stored supplier product information.

12. A system for performing a method of permitting a supplier to transmit a message through an agent to potential customers, the system including a database of personal customer records including customer identification information and customer preference information for each customer, a database of personal supplier information including supplier contact information and supplier product information, an agent which includes information processing means which is responsive to an enquiry from a supplier relating to the supply of a particular product or products, to provide a message from the supplier to customers selected on the basis of the customer preference information.
